(19) United States
(12) Patent Application Publication
(10) Pub. No.: US 2012/0073237 A1
(43) Pub. Date: Mar. 29, 2012

(54) Pipe Support System

(76) Inventor: James M. Brown, Richland Hills, TX (US)

(21) Appl. No.: 12/893,472

(22) Filed: Sep. 29, 2010

(51) Int. Cl. E04D 13/00; F16L 3/00; E04B 1/38; F16L 3/08

(52) U.S. Cl. 52/705; 248/65; 248/70; 248/237; 52/745.21

(57) ABSTRACT

A pipe support system is shown which is used to support an exposed pipe on a surrounding support surface such as the roof of a building. The device includes strut support with a base having a flat bottom for resting on the roof, an upright member of a given length which is connectable to the base at one extent and to a U-shaped channel region at an opposite extent. A pair of the strut supports can be placed in side-by-side relationship with a length of strut material passing between the two and forming a horizontal support surface for supporting the exposed pipe on the roof The length of the upright member can be altered by a user at a job site to thereby provide a device having a desired overall height.

### BACKGROUND OF THE INVENTION

A. Field of the Invention

The present invention relates generally to improvements in support arrangements for exposed pipes and, more specifically, to a support system for an exposed pipe on the roof of a building, in an attic or mechanical room, or the like, such as, for example, the condensate drain line of an air conditioning unit.

B. Description of the Prior Art

A variety of devices have been used in the prior art in order to support exposed pipe. Support devices are necessary for a number of reasons, such as to prevent undue strain being placed upon a pipe or coupling. In some cases, it is necessary to support the pipe at a slope with respect to an adjacent support area, such as in the case of condensate drain lines from air conditioning/heating systems, or in the case of sewer pipes and lines.

Commercial buildings often have various types of pipes which are exposed and run along the rooftops of such buildings. For example, it is quite common for air conditioning units to be mounted on a building roof of a commercial building, the air conditioning units having condensate drain pipes which slope from the unit toward an exit point on the rooftop. Other service units are commonly mounted on building roofs which utilize pipes which must be supported, often at a slope with respect to the surrounding rooftop. Modern building code requirements also dictate that pipes be properly supported in attics, mechanical rooms, and the like, in many situations.

In the past, it was common practice for mechanical and heating/ventilation contractors and roofers to hand saw pieces of wood of the desired height to support air conditioner condensate drain pipes. This procedure is time consuming and labor intensive. It was realized that an adjustable, ready-made device would save time and money.

While various devices are shown in the prior art for supporting pipes, shortcomings continue to exist. For example, U.S. Pat. No. 4,513,934, to Pruyne, issued Apr. 30, 1985, shows a pipe supporting device adapted to receive and support an exposed pipe on a building roof. The device has a base with a substantially flat bottom for resting on the roof and an upwardly tapered structure secured on and rising from the base to provide upwardly divergent, V-shaped recesses for receiving the pipe and supporting it above the base. One problem with the device shown in the '934 patent is that the upright portion of the device is not adjustable in length. As a result, it is not possible to vary the overall height of the device except by stacking multiple devices, one upon the other, thereby adding to the cost of the installation. Of course individual devices of the type shown in the '934 patent could be manufactured of different overall heights, however this would lead to additional expense in manufacture and require that the user maintain an inventory of different height devices in order to provide the slope required at the particular job site.

Applicant's prior U.S. Pat. No. 5,906,341, to Brown, issued May 25, 1999 and U.S. Pat. No. 6,076,778, to Brown, issued Jun. 20, 2000, solved certain of the noted deficiencies of the prior art. They solved the problem of providing an adjustable height for the support by providing an upright member which could be altered by a user at a job site to thereby provide a device having a desired overall height for supporting an exposed pipe. However, some situations required that multiple exposed pipes be supported. In order to support multiple exposed pipes the '341 and '778 patents utilized a PVC cross member as the weight supporting element with multiple exposed pipes being laid upon the cross member. This arrangement worked satisfactorily where the exposed pipes were also of relatively light weight construction, or only a single pipe was being supported. However, if the beam loading was too great there was the possibility of deformation of the PVC cross member. Also, some situations required a more robust assembly to carry greater weight and offer greater stability, than the PVC piping arrangement used in the '341 and '778 patents.

There continued to be a need, therefore, for improvements in the pipe support arts in order to meet the requirements of the previously described situations.

The present invention has as its object to provide a pipe supporting device which is simple in design and economical to manufacture and which can support an exposed pipe at a desired slope with respect to a surrounding support surface, such as a building roof.

Another object of the present invention is to provide such a pipe supporting device which has an upright member which is easily adjustable in length in order to provide a pipe supporting device of a selected overall height at the job site.

Another object of the invention is to provide such a pipe supporting device of standard components which can be mass produced at an economical price but which include height adjustment features to allow the standard device to be adjusted an overall height to fit the installation location at hand.

Another object of the present invention is to provide a pipe support system which provides a horizontal support surface of sufficient width to allow multiple exposed pipes to be supported thereon.

Another object is to provide a pipe support system which allows all of the previously mentioned advantages, such as a height adjustment feature, while making use of a more robust cross support construction which can support greater weight than standard PVC pipe.

### SUMMARY OF THE INVENTION

The present invention uses a strut support in a pipe support system which receives and supports at least one exposed pipe, such as a condensate drain pipe from an air conditioning unit located on a roof of a building. The strut support has a base with a flat bottom for resting on the roof. The base may be provided with a plurality of holes therethrough to facilitate mechanical attachment or adhesive attachment to the roof The base has an upwardly extending receptacle portion. An upright member is provided which is formed of a synthetic plastic material of a first selected length, the upright member having a first extent which is insertable within the upwardly extending receptacle portion of the base to engage the base receptacle portion, and an opposite, second extent.

A strut receiving portion, also molded from a synthetic plastic material, is provided for receiving and supporting a strut in a generally horizontal plane with respect to the roof The strut receiving portion has a downwardly facing receptacle for receiving and engaging the opposite, second extent of the upright member and has a U-shaped channel region, when viewed from the end, which is integrally molded as a part of the downwardly facing receptacle. The U-shaped channel region has a bottom wall and a pair of spaced-apart, opposing sidewalls which extend vertically upward from the bottom wall to form the U-shaped channel. The opposing sidewalls are spaced-apart a predetermined distance which is sized for receiving and securing a length of strut material.

The spaced-apart, opposing vertical sidewalls of the strut receiving portion of the strut support each have at least one outwardly extending ear located thereon. Each ear has an ear opening which is sized to receive a locking strap for securely retaining the length of strut material within the U-shaped channel.

Preferably, each locking strap has a series of ratcheting tabs located along one side thereof for engaging the ear openings in ratcheting fashion. In a particularly preferred form of the invention, the spaced-apart opposing vertical sidewalls of the strut receiving portion of the strut support each has at least two outwardly extending ears located thereon in spaced relationship.

The spaced-apart opposing vertical sidewalls of the strut support terminate in an upwardly extending mouth region of the U-shaped channel. In a preferred form of the invention, the outwardly extending ears are located on the spaced-apart vertical sidewalls in an exterior location adjacent the mouth opening.

The height of the strut receiving portion is adjustable by adjusting the height of the upright member between the base and the strut receiving portion. The length of the upright member can be altered by a user at a job site to provide a device having a desired overall height for supporting the strut material at a desired height.

A pair of strut supports can be arranged side-by-side with a length of strut running therebetween to form a stable horizontal support surface for supporting one or more pipes, such as the condensate drain pipes used in commercial air conditioning systems.

A method is also shown for supporting an exposed condensate drain pipe running from an air conditioning unit located on a roof of a building. In the method of the invention, a pipe supporting strut is placed beneath the pipe at spaced intervals along the pipe. The pipe supporting strut is itself supported by a pair of strut supports, each of which is formed as has been previously described. A given length of strut material is installed between the strut receiving receptacles of a pair of the strut supports with the strut supports arranged in side-by-side locations so that the strut so supported forms a horizontal support surface with respect to the roof. This support surface can then be used to support a length of the condensate drain pipe on the horizontal support surface. Multiple pairs of the strut supports can be arranged beneath the length of condensate drain pipe at spaced locations to provide further support for the pipe.

The method of the invention can also include the additional steps of altering the length of the upright members of selected strut supports at spaced intervals along the exposed condensate drain pipe, to thereby provide a device having a desired overall height for supporting the exposed pipe at a desired degree of slope on a roof or other surrounding substrate. The length of the respective upright member can be altered by severing the length at an approximate desired height. The final desired height of the pipe supporting device is obtained by adjusting the length of the extent residing within either or both receptacle portions, the upright being glued at the final desired height.

Additional objects, features and advantages will be apparent in the written description which follows.

### BRIEF DESCRIPTION OF THE DRAWINGS:

FIG. 1 is a perspective view of one strut support which is used in the pipe support system of the invention, a length of strut material being shown received within the U-shaped channel receiving portion of the support.

FIG. 2 is an exploded view of the strut support of FIG. 1 with the length of strut material being shown spaced-apart for ease of illustration.

FIG. 3 is a perspective view of a pair of the strut support devices of the invention arranged in side-by-side fashion with a length of strut material being supported therebetween, the strut material, in turn, supporting a condensate drain pipe.

FIG. 4 is a simplified view, partly broken away, of a prior art conventional air conditioning unit on a building roof, the unit having a condensate drain pipe which is supported by prior art pipe supporting devices.

FIG. 5 is a simplified side, partial sectional view of a portion of the base of a pipe support of the invention showing the upper surface area coverage of the adhesive used to secure the base to a roof.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

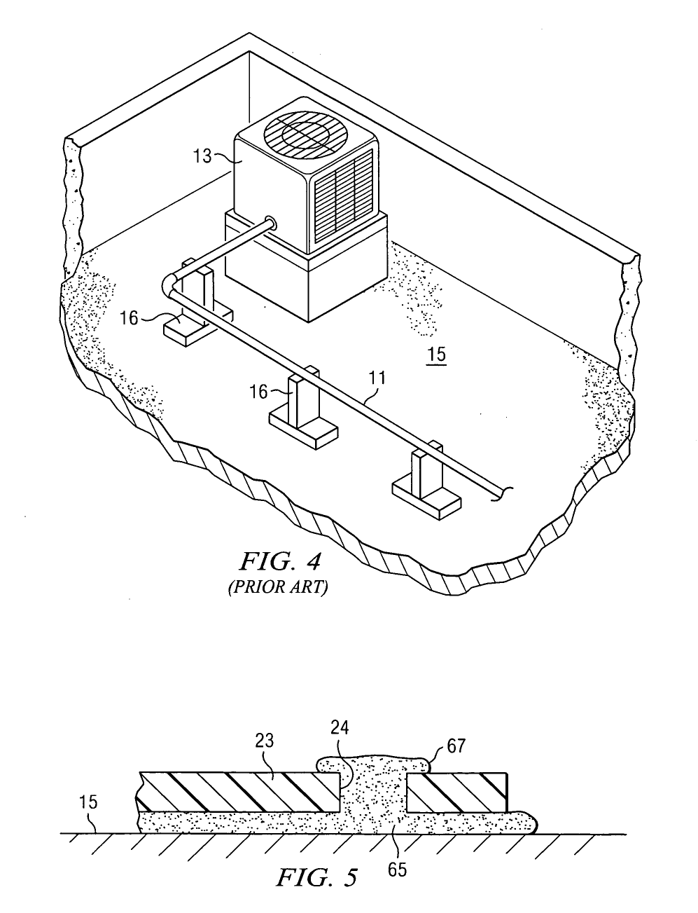

In order to better understand the general environment of the present invention, reference will first be had to FIG. 4 of the drawings which shows a typical installation in which a pipe 11 from an air conditioning unit 13, mounted on the roof of a building 15, extends across the roof to a desired location (not shown) where it exits over the side of the roof, through the roof, or is connected to other roof-mounted equipment. While the invention will be described primarily with respect to roof mounted installations, it will be understood that the devices of the invention could also be used in ground locations, in attics, and other conventional locations where a need exists for pipe support. The roof installations illustrated are particularly well suited for use with the devices of the invention because of the relatively light weight and yet stable construction of the devices. In the prior art example shown in FIG. 4, the pipe has been supported by a workman cutting pieces of wood 16 to an approximate desired length. As has been mentioned, this type solution to the problem at hand was time consuming and often resulted in less than a stable support.

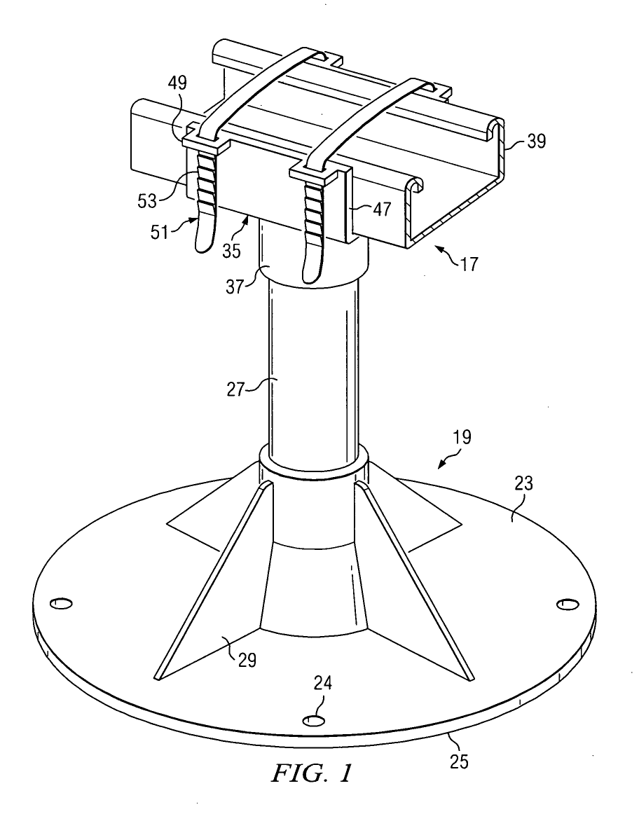

The improved pipe support system of the invention will now be described with respect to FIGS. 1-3 of the drawings. The pipe supporting devices of the invention (such as the device 17 in FIG. 1) are positioned on a surrounding substrate, such as the roof 15 in FIG. 4, to support the pipe 11 as it extends along the roof and would take the place of the pieces of wood shown in FIG. 4. The number of supporting devices needed will depend upon the type of the pipe supported, its size, weight, overall dimensions, and the material from which it is made, as well as the particular layout employed on the roof In general, for air conditioning systems of the type shown, it will be desirable to support the pipe with a gradual slope from the air conditioning unit in the direction of the point at which the pipe extends over the side of the roof or otherwise exits the rooftop. Thus, in the embodiment of the invention shown in FIG. 4, the overall height of the pipe supporting devices will decrease in height from left to right as viewed in FIG. 4.

As best seen in FIG. 1, the improved pipe supporting device of the invention 17 includes a base 23 having a generally round and flat bottom surface 25 for resting on the roof 15 or other surrounding substrate and an upwardly extending receptacle portion 19. The base will also preferably be provided with a plurality of holes 24 around the circumference thereof which provide communication between the bottom and upper surfaces thereof The base 23, as well as most of the other component parts of the device may conveniently be formed of a synthetic plastic type material such as injection molded or extruded polyvinyl chloride (PVC). Other synthetics such as acrylic styrene acrylonitrile copolymers (ASA) may be utilized, as well, and offer improved UV protection and durability.

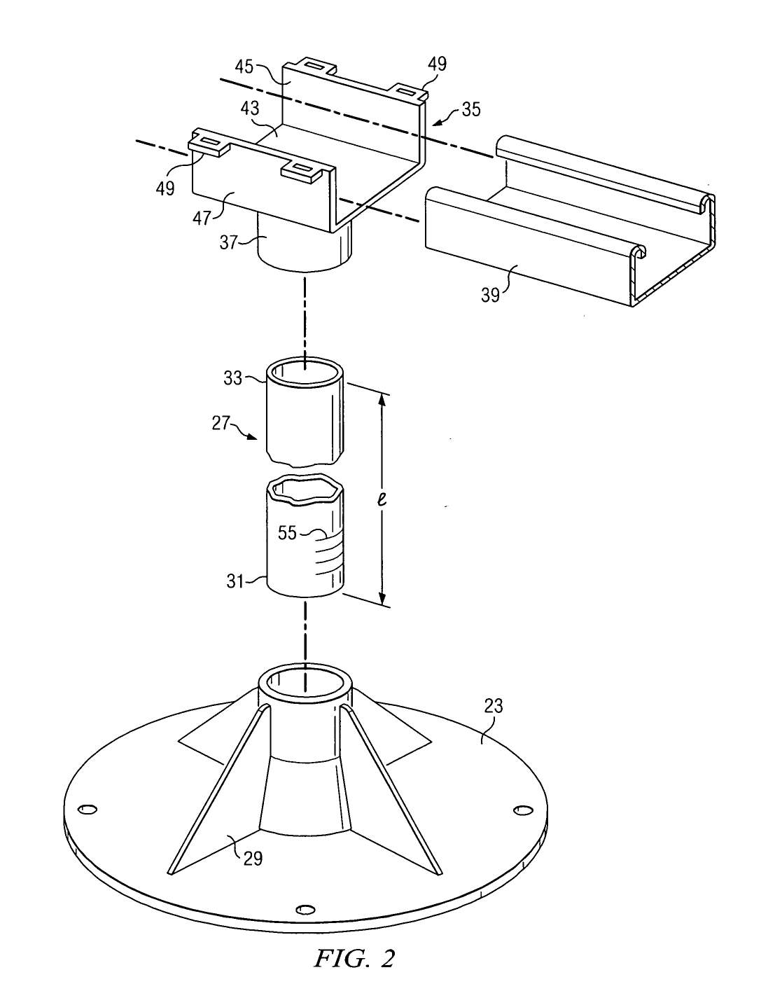

An upright member 27 of a first selected length (“1” in FIG. 2), also formed of PVC or other suitable synthetic plastic type material, is connectable to the base 23 by means of the receptacle portion 19 thereof. As shown in FIG. 1, the receptacle portion 19 is preferably provided with a series of angled flutes or gussets 29 to add strength and stability to the receptacle portion of the device. Each gusset comprises a triangular reinforcing brace for reinforcing the upwardly extending receptacle portion of the device. In the preferred embodiment shown, there are four gussets 29 arranged at equi-angular positions about the upwardly extending receptacle portion on the base. The base 23, as well as the integral receptacle portion 19, are preferably formed in one piece of one of the previously described synthetic plastic type materials.

The upright member 27, which can also be formed of a synthetic plastic material such as PVC, in addition to the first extent 31 (FIG. 2) which is insertable within the upwardly extending receptacle portion 19 of the base, has an opposite, second extent 33. The exemplary upright member 27 shown in FIGS. 1 and 2 is a ¾ inch I.D. length of PVC pipe, where the pipe supporting device is intended to support the condensate drain pipe of an air conditioning unit mounted on a roof.

A strut receiving portion, designated generally as 35 in FIGS. 1 and 2, is connectable to the second extent 33 of the upright member 27 by means of a downwardly facing receptacle 37. The strut receiving portion is adapted to receive and support a length of strut material 39 in a generally horizontal plane with respect to the roof or other substrate. By “strut material” is meant a length of channel iron of the type used in many construction industries and commercially available from a number of sources. One well know product of this type is sold as “Unistrut”® by the Unistrut Corporation of Wayne, Mich. The Unistrut® metal framing system may take many different forms. For example, one of the popular systems is characterized by a channel-shaped metal structural member having in turned edges. A threaded clamping nut is adjustably movable longitudinally inside the channel-shaped member. Parallel grooves are provided to receive the in turned edges of the channel member. A threaded bolt is used to bring and hold the in turned edges of the channel member into engagement with the grooves of the clamping nut as the threaded bolt is tightened. While the strut has been illustrated as commercially available and known ‘strut’ material such as that manufactured by UNISTRUT of Wayne, Mich., the strut may take various forms such as slotted rail that accepts T-shaped bolts to commercially available DIN rail or other possible shapes. As such, the reference to “strut material” illustrated in the drawings of this widely used commercial product should be taken to represent but a single illustrative embodiment of a strut.

As shown in FIGS. 1 and 2, the downwardly facing receptacle 37 of the strut receiving portion of the device is a cylindrical member having an end opening which is similar to end opening in the base 23 for receiving and securely engaging the upright member 27. The strut receiving portion of the device also has a U-shaped channel region 41 which is integrally molded as a part of the downwardly facing receptacle. The U-shaped channel region, when viewed from the end, has a bottom wall 43 and a pair of spaced-apart opposing sidewalls 45, 47, which extend vertically upward from the bottom wall to form a U-shaped channel. The opposing sidewalls are spaced-apart a predetermined distance which is sized for receiving and securing the length of strut material 39. By way of example, the U-shaped channel portion of the device may be provided in sizes ranging from about ½ inch width to about ⅝ inch width for supporting the drain pipes of air conditioning units.

The spaced-apart, opposing sidewalls of the strut receiving portion of the device each have at least one outwardly extending ear, such as ear 49 in FIG. 2, located thereon which forms a portion of an engagement means for the strut support. As can be seen in FIG. 2, the spaced-apart opposing vertical sidewalls of the strut support terminate in an upwardly extending mouth region of the U-shaped channel. Preferably, there are at least four ears 49 with the outwardly extending ears being located on the spaced-apart vertical sidewalls in an exterior location adjacent the mouth opening. Each ear has an ear opening, generally in the form of a rectangular slot for receiving a locking strap (51 in FIG. 1). In this way, a strut which is received and supported within the U-shaped channel portion 35 can be securely engaged within the receiving portion of the device. Preferably, the locking straps 51 are provided with a series of ratcheting tabs 53 located along one side thereof for engaging the ear openings of the ears 49 in ratcheting fashion. The straps are preferably formed of a flexible plastic “tie wrap” type material. It will be appreciated that the straps are adjustable to the height or thickness of the strut material, allowing the strut support of the invention to accommodate any commercially available brand of strut material.

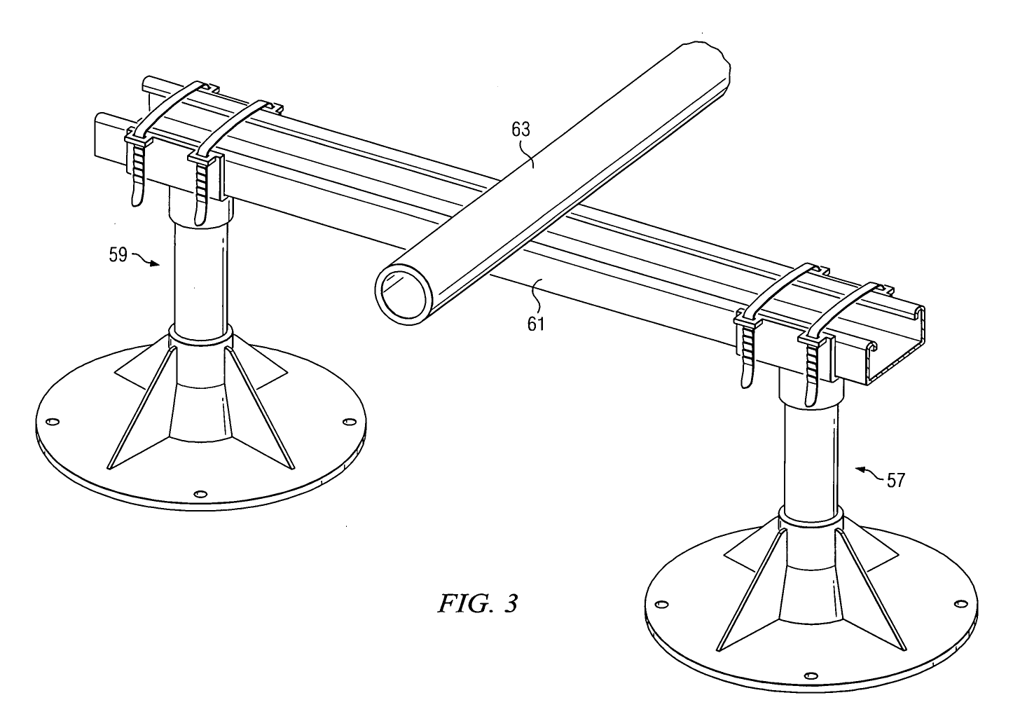

The pipe support system of the invention preferably includes a pair of the previously described strut supports, arranged in side-by-side fashion, as shown by supports 57, 59 in FIG. 3. A length of the strut material 61 can then be run between the two supports 57, 59, to form a stable horizontal support surface for supporting a condensate drain pipe (such as pipe 63 in FIG. 3) thereon. Multiple pairs of the strut supports can be arranged beneath the pipe 63 to provide further support for one or more pipes.

The first selected length of the upright member 27 can be altered by a user at the job site to thereby provide a pipe supporting device having a desired overall height for supporting the exposed pipe 63 at a desired height on the roof Preferably, the upright member 27 is provided with graduations (55 in FIG. 2) along the length thereof and is alterable by severing the length thereof at a selected graduation. In the case of a PVC pipe, this can be conveniently accomplished by sawing the member with a saw, cutting the member with a cutting tool or by breaking the member at a frangible region provided therein. By whatever means, it is only necessary that the user be able to alter the overall length of the upright member 27 at the job site in order to provide a pipe supporting device of a desired overall height to fit the intended location of use. As has been mentioned, in the case of the air conditioner 13 shown in FIG. 4, the condensate drain line 11 is provided with a gradual downward slope as it exits the air conditioner by supplying pipe supporting devices of gradually diminishing height so that condensate easily drains from the air conditioner to a drain point on the roof.

In use, the pipe supporting devices of the invention are installed beneath the pipe to be supported at spaced intervals along the pipe. The flat bottom portion of the base rests upon the associated support structure to provide stability for the device and ensure the firm engagement of the pipe to be supported. The bottom of the device can be cemented to the rooftop or mechanically secured, such as by being nailed or screwed in place using the mounting holes (24 in FIG. 1). The mounting holes 24 also provide another advantage during installation, as illustrated in FIG. 5. In this simplified illustration, a solvent type acrylic cement, such as a LPS Weld-On™ cement adhesive 65 is shown as having been spread on the bottom surface of the base 23. The adhesive has also been pushed up through the hole 24 so that is extrudes out slightly onto the top surface of the base 23, in effect forming a type of locking tab region 67 on the top surface. This locking tab type arrangement has been found to provide greatly improved stability to the pipe support, allowing it to withstand high force winds on roofs, for example.

The overall height which is desired is determined and the upright member 27 is altered to the desired dimensions by severing the upright member at the appropriate graduation 55. The upright member is then installed within the receptacles of the strut support and a length of strut material is positioned so as to span a desired distance between a pair of the strut supports. One or more pipes can then be supported on the length of strut material. The pipe can be secured in place with a locking strap 51 which is passed about the strut exterior and secured after being passed through the opening in the ears 49.

An invention has been provided with several advantages. The pipe supporting device of the invention is simple in design and economical to manufacture. If desired, each of the structural components of the device can be molded or extruded from PVC or other commercially available plastic materials. PVC is generally preferred because it resists deterioration from exposure to ultraviolet light, i.e., sunlight, is fire retardant, and has the requisite strength for most applications. The tie straps can be of any convenient flexible plastic material. The adjustable upright member of the pipe supporting device allows the overall height of the device to be adjusted for supporting an exposed pipe at any of a number of desired heights on a roof or other surrounding support structure. A series of graduations provides a convenient means for determining the overall length of the upright member. Since the upright member is comprised of commercially available PVC pipe, it can be easily cut or sawed to the desired length. This allows a standard sized pipe supporting device to be mass produced which can be altered in overall height to the requirements of a particular job while on the job site. The device is simple to install and saves time over prior art practices, such as cutting and assembling wooden boards to the required heights. The paired strut supports with the intervening horizontal strut material provide a robust and stable support for even heavy pipe installations.

While the invention has been shown in only one of its forms, it is not thus limited but is susceptible to various changes and modifications without departing from the spirit thereof

What is claimed is:

1. A strut support for use in a pipe support system which receives and supports at least one exposed pipe upon a length of strut material, the strut support comprising:
a base having a flat bottom for resting on a surrounding substrate, the base having an upwardly extending receptacle portion;
an upright member formed of a synthetic plastic material of a first selected length, the upright member having a first extent which is insertable within the upwardly extending receptacle portion of the base to engage the base receptacle portion, and an opposite, second extent;
a strut receiving portion molded from a synthetic plastic material for receiving and supporting the length of strut material in a generally horizontal plane with respect to the surrounding substrate, the strut receiving portion having a downwardly facing receptacle for receiving and engaging the opposite, second extent of the upright member and having a U-shaped channel region integrally molded as a part of the downwardly facing receptacle, the U-shaped channel region having a bottom wall and a pair of spaced-apart, opposing sidewalls which extend vertically upward from the bottom wall to form a U-shaped channel, the opposing sidewalls being spaced-apart a predetermined distance which is sized for receiving and securing the length of strut material;
wherein the spaced-apart, opposing vertical sidewalls of the strut receiving portion of the strut support each have at least one outwardly extending ear located thereon, each ear having an ear opening which is sized to receive a locking strap for securely retaining the length of strut material within the U-shaped channel.

2. The strut support of claim 1, wherein each locking strap has a series of ratcheting tabs located along one side thereof for engaging the ear openings in ratcheting fashion.

3. The strut support of claim 2, wherein the spaced-apart opposing vertical sidewalls of the strut receiving portion of the strut support each has at least two outwardly extending ears located thereon in spaced relationship.

4. The strut support of claim 3, wherein the spaced-apart opposing vertical sidewalls of the strut support terminate in an upwardly extending mouth region of the U-shaped channel, and wherein the outwardly extending ears are located on the spaced-apart vertical sidewalls in an exterior location adjacent the mouth opening.

5. The strut of claim 4, wherein the locking straps are themselves also formed of a flexible plastic material.

6. The strut support of claim 1, wherein the height of the strut receiving portion is adjustable by adjusting the height of the upright member between the base and the strut receiving portion, whereby the length of the upright member can be altered by a user at a job site to thereby provide a device having a desired overall height for supporting the strut at a desired height on the roof.

7. The strut support of claim 6, wherein a pair of strut supports are arranged side-by-side with a length of strut material running therebetween to form a stable horizontal support surface for supporting a condensate drain pipe thereon.

8. A pipe support system which receives and supports at least one exposed condensate drain pipe from an air conditioning unit located on a roof, the pipe support system comprising:
a first strut support having a base with a flat bottom for resting on the roof, the base having an upwardly extending receptacle portion;
an upright member formed of a synthetic plastic material of a first selected length, the upright member having a first extent which is insertable within the upwardly extending receptacle portion of the base of the first strut support to engage the base receptacle portion, and an opposite, second extent;
a strut receiving portion molded from a synthetic plastic material for receiving and supporting a length of strut material in a generally horizontal plane with respect to the roof, the strut receiving portion having a downwardly facing receptacle for receiving and engaging the opposite, second extent of the upright member of the first strut support and having a U-shaped channel region integrally molded as a part of the downwardly facing receptacle, the U-shaped channel region having a bottom wall and a pair of spaced-apart, opposing sidewalls which extend vertically upward from the bottom wall to form a U-shaped channel, the opposing sidewalls being spaced-apart a predetermined distance which is sized for receiving and securing the length of strut material;
wherein the spaced-apart, opposing vertical sidewalls of the strut receiving portion of the first strut support each have at least one outwardly extending ear located thereon, each ear having an ear opening which is sized to receive a locking strap for securely retaining the length of strut material within the U-shaped channel; and
wherein a second strut support is arranged in a side-by-side location with respect to the first strut support with a length of strut material running therebetween to form a stable horizontal support surface for supporting a condensate drain pipe thereon.

9. The pipe support system of claim 8, wherein each locking strap has a series of ratcheting tabs located along one side thereof for engaging the ear openings of the respective strut receiving portions of the strut supports in ratcheting fashion, thereby providing an adjustable locking strap which can be adjusted to fit various sizes and heights of strut material.

10. The pipe support system of claim 8, wherein the spaced-apart opposing vertical sidewalls of the strut receiving portions of the strut supports each has at least two outwardly extending ears located thereon in spaced relationship.

11. The pipe support system of claim 10, wherein the spaced-apart opposing vertical sidewalls of the strut supports terminate in an upwardly extending mouth region of the U-shaped channel, and wherein the outwardly extending ears are located on the spaced-apart vertical sidewalls in an exterior location adjacent the mouth opening.

12. The pipe support system of claim 12, wherein the locking straps are themselves also formed of a flexible plastic material.

13. The pipe support system of claim 12, wherein the height of the strut receiving portion of each support strut is adjustable by adjusting the height of the upright member between the base and the strut receiving portion, whereby the length of the upright member can be altered by a user at a job site to thereby provide a device having a desired overall height for supporting the strut at a desired height on the roof.

14. A method of supporting an exposed condensate drain pipe running from an air conditioning unit located on a roof, the method comprising the steps of:
providing a pipe supporting strut beneath the pipe at spaced intervals along the pipe, the pipe supporting strut being itself supported by a pair of strut supports, each of which is formed of synthetic plastic components having a base having a flat bottom for resting on the roof and an upright member connected to an upwardly extending strut receiving receptacle portion;
wherein the strut receiving receptacle portion is formed with a downwardly facing receptacle for receiving and engaging the upright member and having a U-shaped channel region integrally molded as a part of the downwardly facing receptacle, the U-shaped channel region having a bottom wall and a pair of spaced-apart, opposing sidewalls which extend vertically upward from the bottom wall to form a U-shaped channel, the opposing sidewalls being spaced-apart a predetermined distance which is sized for receiving and securing a length of strut material;
installing a given length of strut material between the strut receiving receptacles of a pair of the strut supports with the strut supports arranged in side-by-side locations so that the strut material so supported forms a horizontal support surface with respect to the roof;
supporting a length of the condensate drain pipe on the horizontal support surface so formed.

15. The method of claim 14, further comprising the steps of:
arranging multiple pairs of the strut supports beneath the length of condensate drain pipe to provide further support for the pipe.

16. The method of claim 15, further comprising the steps of:
altering the length of the upright members of selected strut supports at spaced intervals along the exposed condensate drain pipe, to thereby provide a device having a desired overall height for supporting the exposed pipe at a desired degree of slope on roof.

17. The method of claim 16, wherein the length of the upright member is altered by severing the length thereof to an approximate desired height and wherein a final desired height of the pipe supporting device is obtained by adjusting the length of the extent residing within either or both receptacle portions, the upright being glued at the final desired height.

18. The method of claim 17, wherein the upright member is provided with graduations along the length thereof and wherein the length of the upright member is altered by severing the length thereof at a selected graduation at the jobsite.

19. The method of claim 18, further comprising the steps of:
affixing at least selected bases of the pipe strut supports to the roof by applying an adhesive compound between the flat bottom surfaces thereof and the roof.

20. The method of claim 18, wherein the bases are provided with a plurality of holes passing therethrough between the bottom surface and a top surface thereof, and wherein a sufficient quantity of the adhesive is used to allow the adhesive to pass through the holes in the base and extrude outwardly on the top surface to form a locking tab region on the top surface of the base.
